(19) United States
(12) Patent Application Publication
(10) Pub. No.: US 2019/0093925 A1
(43) Pub. Date: Mar. 28, 2019

(54) SOLAR ENERGY SYSTEM

(71) Applicant: Solar Fluidics Pte. Ltd, Singapore City (SG)

(72) Inventors: Edward Laing, Singapore City (SG); Cory Siverson, Singapore City (SG)

(21) Appl. No.: 15/561,250

(22) PCT Filed: Mar. 24, 2016
(86) PCT No.: PCT/GB2016/050861

§ 371 Date: Sep. 25, 2017

(30) Foreign Application Priority Data
Mar. 26, 2015 (GB) 1505168.3

(51) Int. Cl. F24S 80/20; F24S 10/50; F24S 10/20; F24S 10/30; F24S 80/30; F24S 80/52

(52) U.S. Cl. CPC F24S 80/20; F24S 10/50; F24S 10/20; F24S 2020/11; F24S 80/30; F24S 80/52; F24S 10/30

(57) ABSTRACT

A solar panel (302) for heating a target fluid using incident solar radiation is described, the solar panel (302) includes: three major edges (306) arranged so that the solar panel (302) can be inscribed in a triangle with each major edge (308) of the panel (302) lying along at least a portion of a side of the triangle; a cavity for retaining the target fluid; and an inlet and an outlet for the target fluid, for exchanging the target fluid with adjacent solar panels (302).

The present application is directed to the field of solar energy and in particular to capturing and harnessing energy from solar radiation, in particular to convert the energy into useful heat energy in a solar thermal system.

At noon, on a cloudless day at the equator, 1 square metre of the Earth's surface receives around 1000 W of energy. It has long been recognised that this energy could provide a significant contribution to the energy needs of the human population. To date, two different approaches have been pursued to harness this energy. Solar photovoltaic (Solar PV) systems use semiconductor materials, typically based on silicon, to absorb energy from the sun and convert it into electrical energy. Photons incident on the photovoltaic material cause electrons within the material to excite into a higher energy state and enable them to act as charge carriers for an electric current. This electrical energy can be used locally or transmitted onto an electrical grid for transmission over long distances. The solar PV approach is attractive due to the simplicity of its direct conversion of incident solar energy. However, the maximum theoretical efficiency of a solar PV panel is around 50% and typical domestic solar PV systems have an efficiency of around 15%, with the current record efficiency of an operating PV system being only around 40%.

An alternative approach is to use a thermal solar system to convert incident solar energy into heat in a target fluid such as water. In some cases, the target fluid can then be used to generate electrical energy, for example using a steam or gas turbine. However, this requires the use of concentrated solar power using mirrors and lenses to focus the incoming radiation to obtain high enough temperatures in the target fluid (typically around 600-800° C.) to make conversion to electrical energy feasible. In most cases, electricity is not generated but thermal solar systems are used to heat water to 100° C. or less for local use in sterilising, pasteurising, distillation, cooking, space or water heating, drying, cleaning or solar-driven cooling.

In a simple solar thermal flat panel system, a working fluid such as water is passed through tubing, typically made of a black plastic material. The plastic of the tubing absorbs energy from the incoming solar radiation, and heats the water within the tubing. The heated water circulates through the system and can be used directly if the water is the target fluid, for example for washing, or can be passed through a heat exchanger to transfer its heat to another material, for example a storage heating system. The tubing can be maintained within the panel within an evacuated or near-evacuated chamber formed for example using a sealed chamber with a glass surface. The vacuum or semi-vacuum reduces loss of heat from the working fluid back to the atmosphere.

For thermal solar systems that simply convert incident radiation into a heated fluid, efficiencies can theoretically be high, but the efficiency of these systems is limited by factors such as the reflection and/or transmission of solar energy from the absorbing surface and any covering protective layer, such as a glass layer. The efficiency of these systems is also limited by the capacity of the absorbing surface to absorb the incoming radiation, which varies with the temperature difference between the solar panel and its surroundings. Typical efficiencies for flat-plate solar thermal systems are around 50-60%.

According to one aspect, there is provided a solar energy system for heating a target fluid using incident solar radiation, the system comprising:
a protective upper layer;
a target fluid layer comprising the target fluid;
a light transmissive inter-fluidic dividing layer;
a working fluid layer comprising a working fluid; and
a lower retaining layer.

The system provides a solar energy system in which a higher proportion of the energy in the incident radiation is absorbed into the target fluid. In particular, by arranging both the target fluid and the working fluid as layers in the system, for example in a panel, both fluids can be used to absorb incident solar radiation. This can increase efficiency since the target fluid can absorb as much energy as it can directly without requiring heat exchange with another medium. However, the working fluid can be designed to absorb radiation at wavelengths at which the target fluid has poor absorption, hence capturing more of the incident energy in total.

While the order of the layers presented above is preferable for most embodiments, the claimed system is not limited to a particular ordering of the layers. The target fluid may be provided in a layer above or below the working fluid. The arrangement of layers depends on the different wavelength ranges in which each of the fluid absorbs radiation.

However, in most embodiments, the target fluid and the working fluid are arranged such that incoming solar radiation passes through the target fluid prior to passing into the working fluid. In particular, the target fluid layer is positioned above the working fluid layer in the solar energy system such that incident radiation passes through the target fluid layer before reaching the working fluid layer. This maximises the opportunity for the incident radiation to be absorbed directed by the target fluid.

Optionally, the inter-fluidic dividing layer is transparent, alternatively the inter-fluidic dividing layer may be translucent, and in a further variation, the inter-fluidic dividing layer transmits light in a diffusive manner. Transparent dividing layers may allow a greater proportion of the light to enter the working fluid than non-transparent dividing layers. Diffusive or translucent dividing layers can help to spread incoming light rays, rather than focussing them on a small spot.

The inter-fluidic dividing layer may be transmissive to light in at least one of the infrared, visible, and ultraviolet parts of the spectrum. As the solar spectrum at the earth's surface is primarily composed of electromagnetic radiation in these regions of the spectrum, an inter-fluidic dividing layer that is transparent at these frequencies allows a large amount of the incident energy to pass from one fluid to the other, thereby improving the efficiency of the device. Moreover, the inter-fluidic dividing layer is preferably transmissive to light in both the infrared and visible parts of the electromagnetic spectrum. In some embodiments, the working fluid is arranged to absorb light strongly in the visible spectrum, and re-radiate the absorbed energy in the infrared part of the spectrum to be absorbed by the target fluid. Therefore, in such embodiments, it is necessary that the inter-fluidic dividing layer be transmissive to visible radiation, in order that a large proportion of the incoming energy is able to reach the working fluid. Further, the inter-fluidic dividing layer should also be transparent to infrared radiation, so that the re-emitted radiation can be transmitted with low losses to the target fluid.

Optionally, both the target fluid and the working fluid are liquid, although the skilled person will appreciate that the liquid working fluid carries solid particles suspended within it in preferred embodiments. This allows each fluid to circulate and therefore absorb energy more evenly than a solid would. Similarly, liquids are denser than gases, and therefore can store more thermal energy per unit volume than gases can. Using liquids as both working and target fluids therefore improves the overall efficiency of the device.

Optionally, the system further comprises means for circulating the target fluid through the target fluid layer of the system. In particular, the target fluid may be pumped or siphoned from an input connection or zone to an output connection or zone of the target fluid layer. As described in more detail below, target fluid can be passed through the target fluid layer and extracted from the output to be used directly for heating, washing, pasteurising, etc. It will be appreciated that the target fluid may be passed more than once through the solar energy system if the desired temperature has not been reached in a single cycle through the system. Cycling of the target fluid through the panel multiple times can be implemented either by circulating the fluid multiple times through the input connection or by creating a path through the panel that causes the target fluid to flow across the panel multiple times, for example by sectioning the solar panel layer containing the target fluid into multiple sections such that the target fluid flows across the panel multiple times between the input connection and the output connection. In one embodiment, a sensor and valve arrangement may be used to determine the temperature of the target fluid being emitted from the solar system and to redirect the fluid back to the input side for further heating.

In a preferred embodiment, the target fluid comprises water. This includes pure water, filtered and unfiltered water, distilled water and water as a solute, for example in saline or brine.

The working fluid may also be water-based, as described in more detail below. Alternatively, the working fluid comprises oil.

Preferably, the working fluid comprises a colloid comprising a dispersed phase of nanoparticles, preferably comprising carbon nanoparticles. That is, the nanoparticles are suspended within the working fluid. The dispersion medium may be water or oil based. Except for the thicker oils, the dispersion medium is preferably thickened with a high viscosity fluid or thickening medium, such as those described in more detail below, in particular a natural gum or rubber or a lecithin.

Preferably, the absorbance, or absorbency, of the incident radiation in the working fluid is greater than the absorbance of the incident radiation in the target fluid for at least a portion of the spectrum of the incident solar radiation. For example, if the target fluid comprises water, then it is likely to have low absorbance in the visible range of the electromagnetic spectrum. The working fluid can be designed to have high absorbance in the visible spectrum so that the working fluid can be used to absorb the energy that the target fluid cannot absorb and convert it to infrared radiation by radiating the energy as heat. The working fluid can therefore be designed to absorb in portions of the spectrum where the target fluid is less strongly absorbent. In one embodiment, the target fluid absorbs strongly in a narrow range of frequencies, but the working fluid is designed to provide absorption across a broad range of frequencies.

In a particular embodiment, the portion of the spectrum where the working fluid absorbs more strongly than the target fluid comprises visible wavelengths. Preferably, the working fluid emits absorbed radiation at infrared wavelengths. The target fluid can then absorb the emitted infrared radiation.

A preferred embodiment of the system further comprises an upper insulating layer. This is preferably transparent to at least visible and infrared wavelengths of the electromagnetic spectrum. However, the skilled person will appreciate that the layer does not need to be optically clear, but can diffuse the incident radiation providing that the energy is transmitted. The insulating layer may simply comprise an air gap between two layers of plastic or glass. However, preferably, the insulating layer comprises a static air layer. Such a layer may be implemented, for example by providing at least two layers of air separated by a film or membrane. The film helps to stratify the air within the insulating layer and reduces heat loss from the system by convection. An alternative approach to stagnating the air within the insulating layer is to provide a structure in some or all of the insulating gap that maintains the air in separate pockets, such as a honeycomb structure or structure of sealed air pockets, which may be manufactured from a plastics material.

Preferably, the lower retaining layer comprises a reflective layer for reflecting radiation back through the overlying layers. Hence any energy that has not been absorbed on a first pass through the layers of the solar energy system may be absorbed as it passes through the layers on the way out of the solar energy system.

In one embodiment, the transfer of energy between the working fluid and the target fluid predominantly comprises radiant transfer.

According to another aspect, there is provided a high shear mixing system for dispersing nanoparticles in a dispersion medium, to manufacture a working fluid for a solar energy system, comprising:
a surface for receiving the dispersion medium and the nanoparticles;
a blade; and
means for mounting the blade wherein the means for mounting is arranged at a predetermined distance from the surface; and
means for moving the blade across the surface.

By moving the blade across the surface, a large force can be applied to the nanoparticles to mix them evenly into the dispersion medium. The blade can be pressed against the surface, causing the blade to bend and exert a force on the surface. When the blade is dragged through the mixture of dispersion medium and nanoparticles, the force exerted on the blade is transmitted to the mixture, mixing it. Due to the blade pressing against the surface, only a small amount of the mixed dispersion medium and nanoparticles passes under the blade, and forms a thin layer on the surface, while the remainder of the mixture is pushed ahead of the blade as it moves over the surface.

Optionally, the predetermined distance between the means for mounting the blade and the surface in the high shear mixing system is adjustable. The distance between the means for mounting the blade and the surface determines the thickness of the layer left behind, as the blade moves across the surface. In a first example, when the blade does not touch the surface, the thickness of the layer may be determined by the distance between the lower edge of the blade and the surface. In a second example, when the blade does touch the surface, reducing the distance between the means for mounting the blade and the surface applies pressure to the blade, and causes it to bend. When the blade is moved across the surface in this situation, the bending of the blade exerts a force on the mixture, and a thin layer of the mixture is able to pass under the blade. The closer the means for mounting the blade is to the surface, the more force is exerted, and the thinner the layer of mixture which is formed behind the blade as it moves. Thus moving the means for mounting the blade closer to the surface in this example allows a very thin layer to be accurately and reproducibly produced and therefore provides a well-mixed layer of dispersion medium and nanoparticles.

In this example, the blade may be made from any suitable material, with the material selected so that its springiness provides the desired layer thickness. While metal blades may be used, it has been found that small impurities of metal can greatly diminish the effectiveness of carbon nanoparticles in absorbing incident radiation. Therefore, when the high shear mixing system is used to manufacture a working fluid comprising carbon nanoparticles, for example for use in the solar energy systems and solar panels described herein, it is preferable to use a non-metallic blade, for example made from plastic or rubber materials.

Optionally, the means for moving the blade rotates the blade in the plane of the surface. By arranging the means for moving the blade to move in a rotational manner, the blade is able to pass over the surface many times in a single pass. This means that there can be a constant stream of the mixture of dispersion medium and nanoparticles passing under the blade. The blade can be moved in this rotational manner for a long time. For example, rotating the blade at 100 rpm for one week gives a little over one million rotations. This large number of rotations means that it is overwhelmingly likely, statistically speaking, that every nanoparticle has passed under the blade, and correspondingly that the result is a fluid in which the nanoparticles are highly dispersed in the dispersion medium.

According to a further aspect, there is provided a method of manufacturing a working fluid for a solar energy system comprising:
providing a plurality of nanoparticles;
providing a dispersion medium having a viscosity of greater than 500 cP, preferably greater than 800 cP;
dispersing the nanoparticles within the dispersion medium in a high shear mixing system.

The use of a high shear mixing system together with a dispersion medium of sufficient viscosity to retain the particles in suspension once they have been mixed can enable the working fluid to be manufactured without the use of additional chemicals or additives.

Optionally, the method further includes mixing or coating the plurality of nanoparticles with a surfactant prior to dispersing the nanoparticles within the dispersion medium. In some embodiments, the nanoparticles may already be mixed or coated with a surfactant as a result of the method of manufacturing the nanoparticles themselves. Retaining any remaining surfactant on the nanoparticles can assist in the dispersion of the nanoparticles within the dispersion medium.

The method of manufacturing a working fluid may make use of the high shear mixing system described above, and the mixing process may further include the steps of:
placing the dispersion medium and the nanoparticles on the surface; and dragging the blade across the surface. Optionally, the blade is dragged across the surface a plurality of times, for example many tens of thousands of times. As discussed above, the use of this mixing system provides high shear mixing, with reliable control of the shear forces. Allowing the blade to pass across the surface multiple times results in an extremely well mixed working fluid.

There is also described herein a working fluid for a solar energy system, wherein the working fluid comprises a colloid comprising:
a dispersion medium having a viscosity of greater than 1 cP, preferably greater than 300 cP; and
a dispersion phase, wherein the dispersion phase comprises carbon nanoparticles; wherein the dispersion phase is dispersed within the dispersion medium using a high shear mixing system.

According to a further aspect, there is provided a fluid for absorbing incident radiation in a solar energy system, wherein the fluid comprises a colloid comprising:
a dispersion medium having a viscosity of greater than 800 cP and less than 1200 cP;
a dispersion phase of nanoparticles.

In one embodiment, the dispersion phase is dispersed within the dispersion medium using a high shear mixing system.

Preferably, the nanoparticles comprise carbon nanoparticles.

The following features apply equally to the preceding method and system aspects.

Optionally, the fluid further comprises a surfactant, and the carbon nanoparticles may be mixed with the surfactant prior to dispersion within the dispersion medium.

In one embodiment, the dispersion medium comprises water and a high viscosity fluid for thickening the dispersion medium, optionally a lecithin. Alternatively, the dispersion medium comprises oil, optionally castor bean oil.

Optionally, the working fluid further comprises a wax for increasing the viscosity of the dispersion medium, optionally the wax comprising carnauba wax.

Optionally, the carbon nanoparticles comprise at least 3% by weight, preferably at least 5% by weight, further preferably at least 6% by weight of the working fluid.

Optionally, the carbon nanoparticles comprise less than 10% by weight, preferably less than 8% by weight, further preferably less than 7% by weight of the working fluid.

An amount of around 6.6% by weight of the carbon nanoparticles within the fluid has been found to provide a good absorption of the incident radiation.

The carbon nanoparticles may comprise many different shapes and dimensions of nanoparticles, however, the nanoparticles preferably comprise tube-shaped carbon nanoparticles, optionally the nanoparticles comprise at least 25% tube-shaped carbon nanoparticles, preferably at least 50%. The tube-shaped nanoparticles may be carbon nanotubes, or may comprise graphene sheets rolled into tube shapes. Such rolled tubes are encompassed within the definition of carbon nanotubes as used herein. The properties of carbon nanotubes have been found to enable good absorption of the incident radiation.

Optionally, the working fluid further comprises a high transmissivity material, optionally comprising a material with a transmissivity greater than 70%.

The high transmissivity material may comprise a material with a high refractive index, optionally with a refractive index greater than 1.4.

Suitable high transmissivity materials include CaF₂ and SiO₂.

The working fluid may comprise the high transmissivity material in a ratio of less than 0.1% by weight of the high transmissivity material to the nanoparticles. Hence the high transmissivity material is present only in small proportions in relation to the nanoparticles or the dispersion medium.

According to a further aspect, there is provided herein an impedance matching layer for electromagnetic radiation, the impedance matching layer comprising:
a first composite having a first impedance to the transmission of electromagnetic radiation;
a second composite having a second impedance to the transmission of electromagnetic radiation, different to the first impedance;
wherein each composite comprises a carrier material and a dopant, the carrier material and the dopant having different impedances to the transmission of electromagnetic radiation;
wherein the first composite comprises a first proportion of the dopant in relation to the carrier material to provide the composite having the first impedance to the transmission of electromagnetic radiation; and
wherein the second composite comprises a second proportion of the dopant in relation to the carrier material to provide the composite having the second impedance to the transmission of electromagnetic radiation.

Hence by using a carrier material and a dopant in varying proportions, composites of different impedance can be formed and these composites can be used to create an impedance matching layer for electromagnetic radiation. The impedance matching layer is therefore formed having a profile with an impedance to electromagnetic radiation that varies through the thickness of the layer, hence enabling incoming electromagnetic radiation to transition more efficiently and with reduced reflection losses from a material on one side of the matching layer to a material on the other side of the matching layer.

Optionally, the impedance matching layer comprises at least one intervening composite having an impedance to the transmission of electromagnetic radiation with a value between that of the first composite and the second composite.

Optionally, the impedance matching layer is designed for placement at an air/solid interface and the matching layer increases the transmission of incident energy from the air into the solid and vice versa.

In this embodiment, the impedance of the first composite is closer to that of the air than that of the solid. The impedance of the second composite is closer to that of the solid than of the air.

In one embodiment, the solid comprises glass or plastic.

In one embodiment, the dopant has a lower impedance to the transmission of electromagnetic radiation than the carrier and is therefore present in higher proportions in the composite that has a lower impedance.

The dopant may comprise an aerogel, optionally a silica-based aerogel. The carrier may comprise a silicone, for example a silicone rubber. In particular, using a silica based aerogel in combination with a silicone rubber is particularly beneficial. This is because the particles of dopant typically have characteristic sizes about as large as, or larger than, the wavelength of light in the ultraviolet, visible and/or infrared parts of the spectrum. This could reduce the effectiveness of the doping, since the dopant particles act like small pockets of different impedance material, rather than causing the entire composite to behave as though it had an impedance between that of the dopant and that of the carrier. However, using silica aerogel dopant in a silicone rubber carrier mitigates this unwanted effect, since the interface between the silicone rubber and the silica aerogel is not a sharp boundary. This means that the dopant particles behave less like isolated pockets of different impedance, and more like a dopant, modifying the impedance of the composite as a whole.

Moreover, the aerogel is hydrophobic, which may provide a self-cleaning effect on an outer surface of the first composite. Self-cleaning is an important property for an impedance matching layer, since if the outer surface is dirty, less light will make it into the layer to start with.

Optionally, the impedance matching layer comprises a composite of thickness t, related to a wavelength of light in the composite, λ, which is in the part of the electromagnetic spectrum at which solar power at the earth's surface is maximum by the relationship:

$$t = \frac{n λ}{4}$$

wherein n is any positive odd integer.

When light transitions from one material to another, it is transmitted best when the wave is at its peak amplitude at the boundary. This corresponds to being a quarter way through a cycle (or equivalently three-quarters of the way through a cycle). Since the impedance matching layer is arranged to transmit light at a wide range of wavelengths, spanning the ultraviolet, visible and infrared parts of the spectrum, it will not be possible to match the thickness of a composite to every wavelength. Instead, particular wavelengths must be selected to benefit from this effect. It is therefore beneficial to select a wavelength in the region at which the solar energy received at the earth's surface is at or near a maximum. The skilled person will appreciate that there will be a range of wavelength values for which the power of the incident radiation is high, or above a threshold level. Hence there will be a range of acceptable wavelengths, λ, over which the above formula to determine the thickness, t, could be applied and a corresponding range of acceptable thicknesses for the matching layer.

Additionally, it is often difficult to accurately form the composite to the correct thickness, because the required thicknesses require the ability to control thickness to the order of a few tens of nanometres. In addition, the wavelength of light changes depending on the refractive index of the material. Therefore, the thickness of each composite would need to be different from the thickness of each other composite to benefit from the effect described above. Because of these complications, it is often not possible to accurately choose a single wavelength which will benefit from this effect. Instead, the impedance matching layer can be reproducibly manufactured with a small range of wavelengths in mind, but the actual wavelength or wavelengths which benefit from this effect likely to vary within a range.

Optionally, λ, corresponds to a frequency of between 6×10¹⁴ Hz and 1×10¹⁵ Hz. This corresponds to the region of maximum power delivered to the earth's surface by the sun, and roughly spans the near ultraviolet to the green part of the spectrum.

According to another aspect, there is provided a solar panel for heating a target fluid using incident solar radiation, the solar panel comprising:
three major edges arranged so that the solar panel can be inscribed in a triangle with each major edge of the panel lying along at least a portion of a side of the triangle; a cavity for retaining the target fluid; and
an inlet and an outlet for the target fluid, for exchanging the target fluid with adjacent solar panels.

By making solar panels in a shape which is based on the triangle, it is possible to tile large areas, since triangles tessellate. In this context, the three major edges of the panel are the three longest edges. For example, when the edges of the panel lie along the whole length of the sides of the triangle, the panel itself will also be triangular, and therefore have only three edges. In this case, these three edges correspond to the full lengths of the major edges.

In other embodiments, the major edges of the panel lie along only a portion of the triangle. In this case, the major edges are joined together by minor edges, and the shape of the panel may be that of a truncated triangle with the corners removed, which can also be thought of as an irregular hexagon.

The solar panel may comprise the inlet and outlet being located adjacent to a corner of the triangle. While other shapes also tessellate (squares, rectangles, hexagons etc.), a further advantage of triangle-based shapes is that a large number of connections can be made between adjacent triangles when the inlet and outlet are located adjacent to the corner of the triangle. For example, comparing triangles to other shapes which tessellate, a hexagon can connect to at most 6 adjacent hexagons, squares or rectangles can connect to up to 8 adjacent squares or rectangles, but triangles are able to connect to up to 12 adjacent shapes. Therefore, when triangle-based shapes are used, the target fluid can flow out of one panel to a large number of neighbouring panels, thus providing a flexible network.

The solar panel may comprise three inlets and three outlets. Moreover, optionally one inlet and one outlet are located adjacent to each corner of the triangle. As explained above, locating inlets and outlets near the corners of the triangle, in particular locating them on the minor edges of the panel, if the panel has minor edges, provides a flexible network.

The solar panel may be shaped as a truncated triangle, having three major edges alternated with three minor edges, wherein the minor edges are shorter than the major edges. Truncating a triangular panel provides a space when the panels join together, in which the inlets and outlets of adjacent panels may be connected together.

The major edges of the solar panel may be at least 3 times as long as the minor edges, and optionally the triangle is equilateral.

In a feature that may be provided in conjunction with or independently of the triangular panel shape, the cavity of the solar panel for retaining the target fluid may comprise an internal structure shaped to increase the time spent in the panel by the target fluid by forcing the target fluid to follow a path between an inlet and an outlet which is longer than the straight line path. By forcing the target fluid to spend more time in the panel, the target fluid is able to reach a higher temperature. Optionally, the cavity is defined by a moulded plastic sheet, or a plurality of plastic sheets connected between the upper and lower surfaces of the cavity containing the target fluid. This allows the panel to be produced easily and cheaply.

Optionally, the internal structure of the panel causes the target fluid to circulate within the panel. For example, the fluid can take a spiralling path through the panel.

The solar panel may be provided in different sizes, for example a large panel may have major edges which are between 0.9 m and 1 m; the major edges of an intermediate panel may be between 0.5 m and 0.7 m; and the major edges of a small panel may be between 0.2 m and 0.4 m. In preferred embodiments, an array of 6 or so of the smaller panels is arranged to provide enough hot water for a single user in equatorial regions.

The solar panel may further comprise the solar energy system described above. The use of a target fluid in combination with a working fluid can improve the performance of the system, as described above.

Optionally, the working fluid is a fluid for absorbing incident solar radiation as described above.

According to a further aspect, there is provided a network of solar panels for heating a target fluid using incident solar radiation, the network comprising:
a first solar panel; and
a second solar panel; wherein
the first and second solar panels each include a cavity for retaining a target fluid, and the first and second solar panels are coupled together to allow the target fluid to flow between them; and

further comprising means for selectively enabling fluid flow into each panel.

When fluid flow is selectively enabled into the panels, the flow can be directed around the network. For example, the flow may be directed based on how hot each panel is. When a panel is cooler, for example because it is in the shade, target fluid is not sent to that panel, as it would not be able to contribute to the heating of the target fluid. The efficiency of the network is therefore improved by avoiding cooler panels.

Preferably, flow through an array of solar panels is controlled by restricting or enabling the inflow of fluid into a panel. However, the outflow of fluid from a panel is not restricted.

The solar panels forming part of the network are preferably the solar panels described above.

Optionally, the solar panels in the network are arranged adjacent to one another, coupled along one of their major edges. As described above, connecting the solar panels together along their major edges means that the panels meet at their corners (or minor edges). This provides each panel with up to 12 adjacent panels to exchange target fluid with, and provides a flexible network.

The solar panels in the network may be joined together adjustably and/or flexibly so that the distance and/or angle between adjacent panels is variable. This allows the panels to be mounted on surfaces with complex underlying geometry, since the network can flex to fit the panels to the underlying surface.

Optionally, each panel has an inlet and an outlet coupled to an adjacent panel, and the flow of target fluid is controlled by selectively opening or closing inlets.

Optionally the target fluid can flow in either direction between adjacent panels.

The flow of target fluid around the network is controlled by valves configured to open above a first predetermined temperature, and close below a second predetermined temperature. A suitable switching temperature may be 60° C. as this is a temperature high enough to kill most water-borne pathogens. Thus, allowing water to flow into panels which are at around 60° C., and preventing flow into those below this temperature can help to ensure that all water in the system is sanitised.

The valves in the network may comprise a physical valve, arranged to change shape and/or size in response to temperature. For example, the physical valve may be a diaphragm having a dome-shaped body, configured to invert itself in response to stresses generated by thermal expansion or contraction of the diaphragm. Arranging the valves to operate in this way means that there need not be complex control systems in place. Instead, bypassing of cooler panels is an inherent feature of the system.

According to a further aspect, there is provided a diaphragm for use in a temperature controlled valve, comprising a dome-shaped body, configured to invert itself at a predetermined temperature in response to stresses generated by thermal expansion or contraction of the diaphragm. Such a diaphragm is cheap and easy to produce.

The temperature at which the diaphragm inverts itself may be determined by the geometry or materials of the diaphragm. This allows a variety of different diaphragms to be produced, depending on the intended use.

Optionally, the diaphragm is made of a plastics material, for example the diaphragm is made in part from polyvinylidene fluoride (PVDF) or polypropylene. The diaphragm may be made from more than one material, each material having a different coefficient of thermal expansion. Plastics are cheap, readily available, and easy to shape.

The diaphragm may have a thickness which varies across the diaphragm. This provides a manner in which the temperature at which the diaphragm inverts itself can be set during production.

It will be appreciated that aspects of the invention described above may be implemented alone or in conjunction with other aspects. Preferred features of one aspect may be applied to other aspects. Apparatus for implementing the methods described and methods of operating the apparatus described are also provided. There are also provided computer programs, computer program products and computer-readable media comprising instructions for operating apparatus for manufacturing and controlling the systems described herein.

Embodiments of the apparatus and methods described herein will now be described in more detail with reference to the drawings in which:

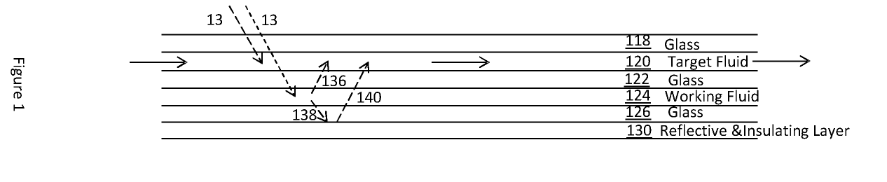

FIG. 1 is a schematic diagram of a solar thermal system according to one embodiment;

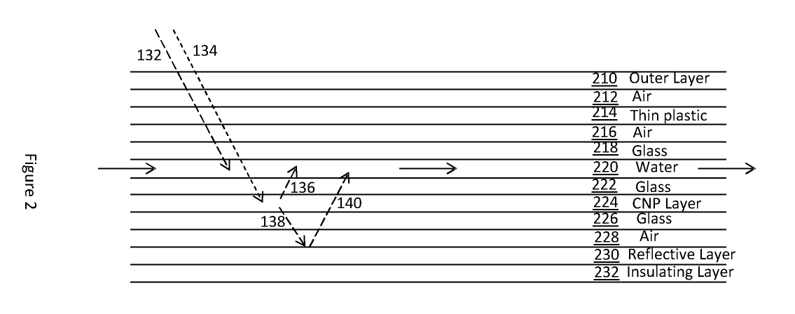

FIG. 2 is a schematic diagram of a solar thermal system according to a further embodiment;

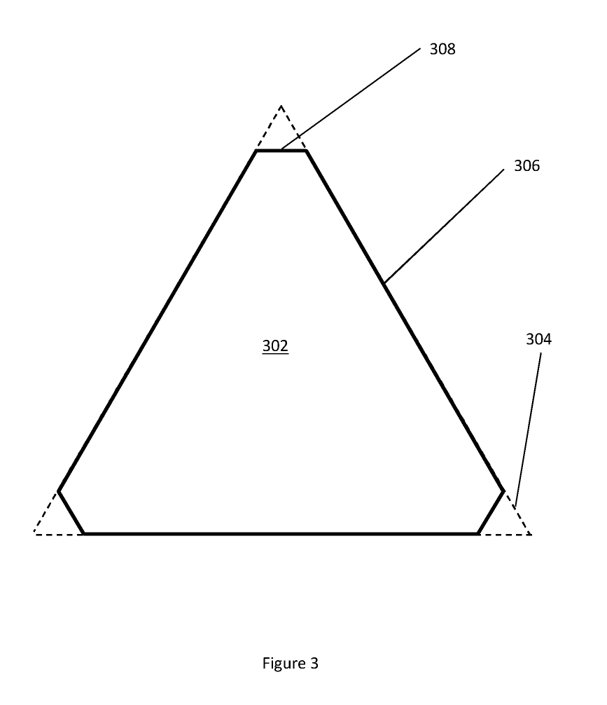

FIG. 3 is a plan view of a solar panel according to an embodiment;

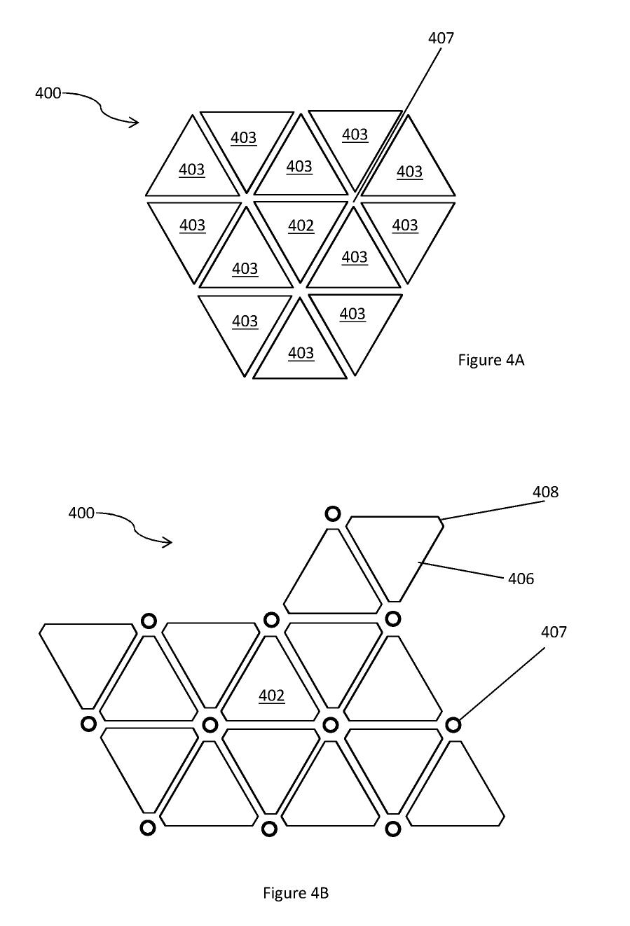

FIGS. 4A and 4B are plan views of a network of solar panels according to an embodiment;

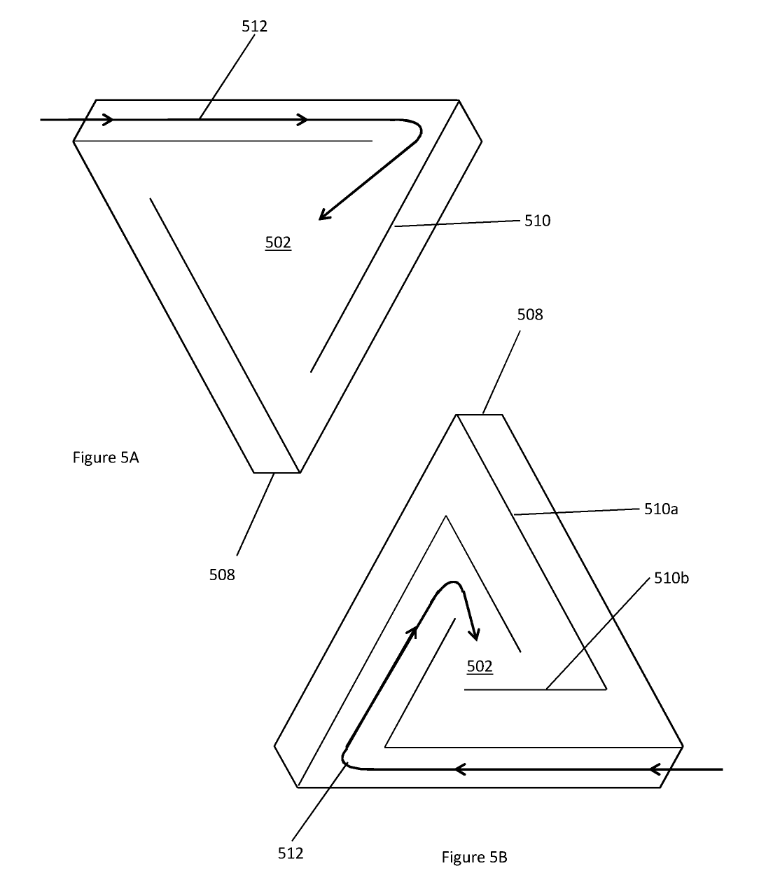

FIGS. 5A and 5B are plan views of solar panels according to another embodiment;

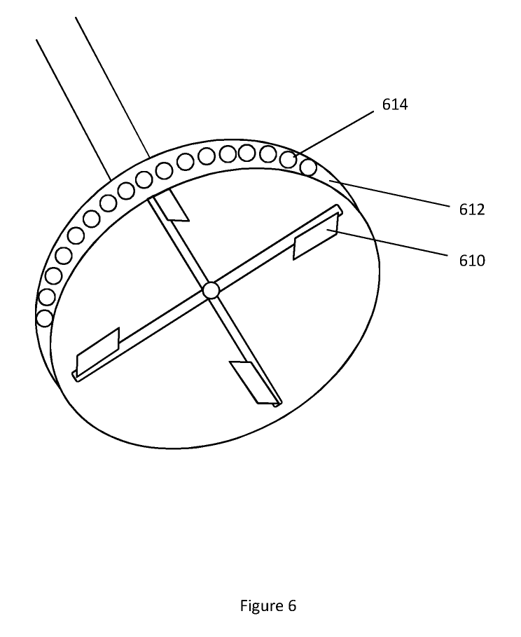

FIG. 6 is a schematic diagram of a high shear mixer;

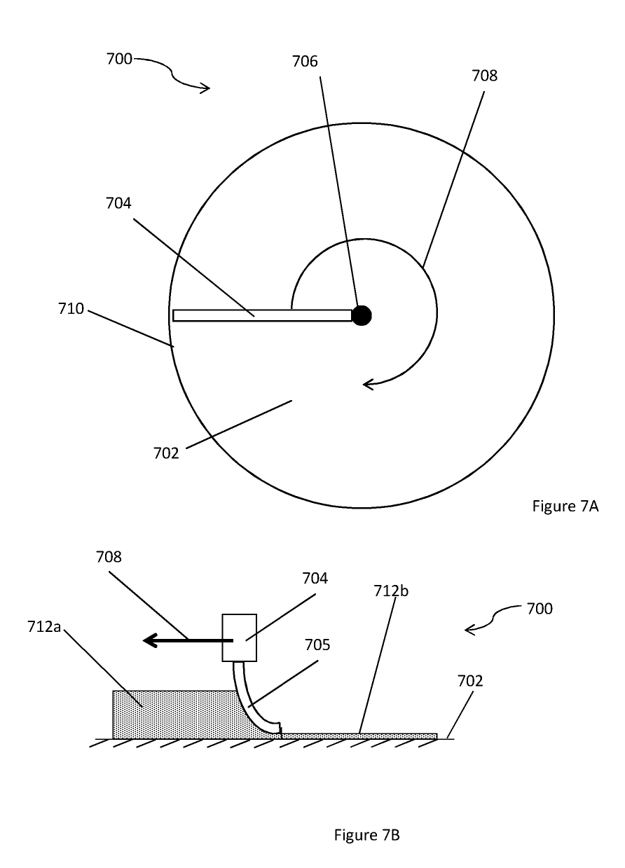

FIGS. 7A and 7B are schematic views of high shear mixers according to yet another embodiment;

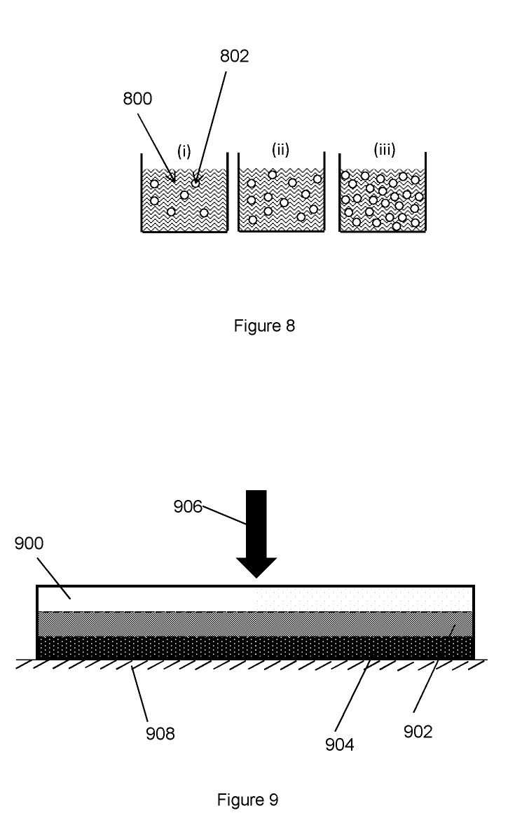

FIG. 8 illustrates a step in the manufacture of an impedance matching layer according to one embodiment;

FIG. 9 illustrates an impedance matching layer according to one embodiment;

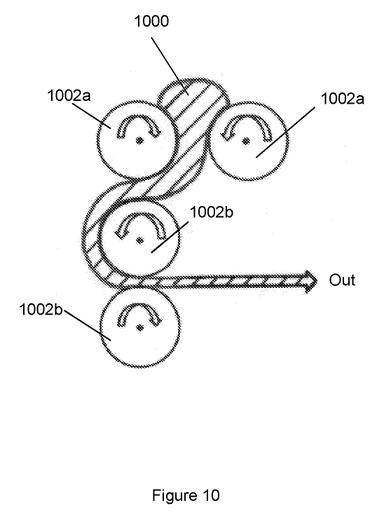

FIG. 10 illustrates a calendering process in the manufacture of an impedance matching layer according to one embodiment;

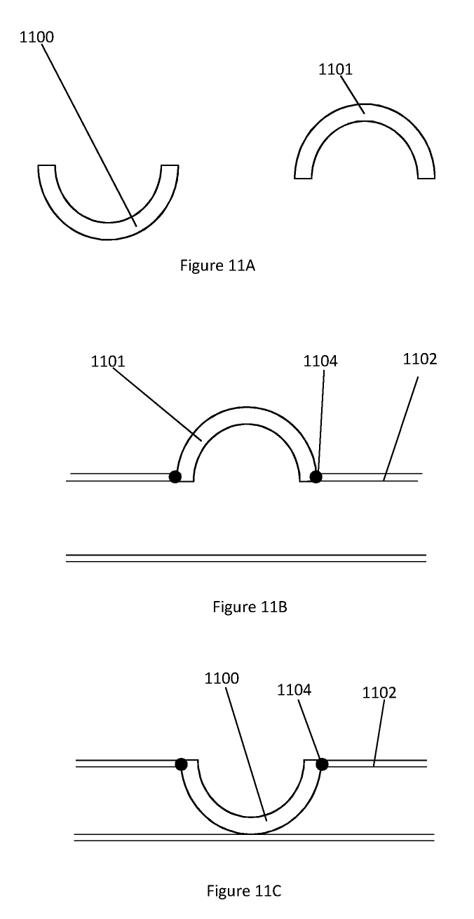

FIG. 11A is a schematic illustration of a diaphragm according to one embodiment; and

FIGS. 11B and 11C provide a schematic illustration of the diaphragm of FIG. 11A in use as a valve in a pipe.

FIG. 1 illustrates schematically an embodiment of solar thermal system. The system comprises a number of layers stacked in a flat-panel arrangement. The first, or upper layer comprises a protective glass layer 118 which provides some structural stability and protection for the panel. Glass is rigid, scratch resistant, and is transparent to a broad spectrum of the incident electromagnetic radiation, so it is a suitable material to use for the upper layer of the solar thermal system. However, the skilled person will appreciate that other materials such as a transparent plastic may also be suitable. It will be appreciated that the upper layer need not be optically clear, but may diffuse the light.

Below the upper glass layer there is provided a layer of the target fluid 120. The target fluid is the fluid into which the solar thermal system is designed to transfer the solar energy. Typically, the target fluid comprises water. Water is transparent to some wavelengths of the incident solar radiation, in particular the radiation at visible wavelengths and higher. Therefore, a large proportion of the incident radiation will pass directly through the water 134. However, water is opaque to radiation at infrared wavelengths. Therefore, the incident radiation at infrared wavelengths and lower is absorbed 132 into the target fluid on entry into the system and hence can be used to heat the water directly. This minimises the number of layers that this useful part of the spectrum of the incident radiation must pass through before absorption by the target fluid.

A further advantage of enabling the incident radiation to pass first through the target fluid, at least in some embodiments, is that the incident ultraviolet radiation will have a pasteurising or anti-microbial effect on the target fluid. This may be helpful, for example, in a system designed to pasteurise water.

The target fluid is supported by a further glass layer 122, which also separates the target fluid 120 from the layer of working fluid 124. In fact, so long as light is transmitted through this further layer 122 (also called an inter-fluidic dividing layer), it is possible to use both the working fluid 124 and the target fluid 120 to extract energy from sunlight. Therefore, any material, such as light-transmissive plastics may be used for the inter-fluidic dividing layer 122.

Since a large proportion of the solar energy incident on the surface of the Earth is in the infrared, visible, and ultraviolet regions of the electromagnetic spectrum, it is preferable that the inter-fluidic dividing layer 122 is transmissive to light in any one of these regions. Preferably, the layer 122 is transmissive to light in the infrared and visible portions of the spectrum, as these two regions combined account for a majority of the sun's energy which reaches the earth's surface.

In this context, “transmissive” means that the light is not blocked by the layer. For example, the light may pass through almost entirely unaffected, if the layer is transparent. Alternatively, the layer may be diffusive or translucent, in which case, the incident light rays are substantially scattered in an incoherent manner, but nonetheless pass through the layer.

The working fluid is designed to have a high absorption of incident radiation at wavelengths at which the target fluid has a poor absorption. In particular, as described in more detail below, the working fluid is designed to absorb a high proportion of the radiation incident at wavelengths within the visible part of the spectrum. Absorption of the radiation causes the working fluid to heat up and to emit infrared radiation 136, 138. This infrared radiation is transmitted 136 or reflected 138 back to the target fluid 120 for absorption.

Below the working fluid there is provided a lower glass layer 126, which covers a reflective and insulating layer 130 shown in FIG. 1 as a single layer, but which may be provided as two separate layers. In particular, the reflective layer may be provided by adding a reflective coating to the lower surface of the glass layer 126. The insulting layer can be formed of any suitable organic or inorganic material such as polystyrene, polyester or another plastics-based material or insulating felt or wool.

The target fluid from any of the systems described herein may be used directly for drinking, cooking, heating or washing, or may be used for sterilising, pasteurising other fluids or items. The heated fluid may also be used for space or water heating, drying, cleaning or solar-driven cooling. The systems described herein may also be used as part of a distillation process, for example for the desalination of salt water. While the target fluid is preferably used directly, it is possible to transfer the energy from the target fluid into another medium, such as another fluid, or into another form, such as electrical energy, outside the solar thermal system illustrated in FIG. 1.

FIG. 2 is a schematic diagram of a solar thermal system according to a second embodiment. The system of FIG. 2 incorporates all of the elements of FIG. 1 described above, but includes a number of additional layers to improve the performance or robustness of the system.

In particular, the upper glass surface of the panel is covered with additional layers to decrease the heat loss from the panel and provide additional strength and resilience to the panel. The panel is covered with an outer glass or plastic-based layer 210, embodiments of which will be discussed in more detail below.

Below the outer layer 210 is an air gap comprising two sealed sections 212, 216 filled with air and separated by a thin plastic film 214 or membrane. The thin plastic layer stratifies the air within the air gap 212, 216, reducing movement of the air in this space and therefore reducing the movement of heat between the outer layer 210 and the glass surface 218. The plastic film can be manufactured from any suitable plastics material, for example polyethylene (HDPE or LDPE) or polyvinyl chloride.

This outer structure, including the outer layer and the stratified air gap, reduces loss of heat from the target material in the solar panel.

The outer structure is followed by the layers already described above in relation to FIG. 1; an upper glass layer 218, the target fluid in this case comprising water 220, a second glass layer 222, the working fluid in this case comprising a carbon nanofluid 224 and a third glass layer 226.

Advantageously, a further air gap 228 is arranged below the third glass layer 226 to provide insulation and reduce heat loss from the lower surface of the panel. The final layers comprise a reflective layer 230 and an insulating layer, as in the embodiment of FIG. 1, but these are provided as two separate layers in this embodiment.

It is desirable to make each layer in the panels described in FIGS. 1 and 2 as thin and light as possible while still enabling it to maintain its functionality. Typically, each glass layer will be around 1 mm thick and the layers of the target and working fluids will be 0.5 mm-1 mm in thickness. Other layers may be much thinner, however; in particular, it is not necessary to make the thin film layer thicker than around 0.01 mm and the reflective layer may simply comprise a thin layer of foil that is also around 0.01 mm in thickness, or simply a coating painted onto an adjacent glass or insulating layer. The total thickness of a panel such as that illustrated in FIG. 2 should be less than 20 mm, preferably less than 15 mm, preferably around 10 mm in thickness.

Reducing the thickness of the panel reduces its cost since it reduces the amount of material required to manufacture the panel. It also results in a lighter-weight panel, making the panel easier and cheaper to transport, install and use.

It is further noted that none of the solid layers in the panels described above with reference to FIGS. 1 and 2 need to be optically clear and, in fact, providing diffuse optical layers can reduce the loss of unabsorbed electromagnetic energy from the panel, since it is more difficult for the energy to reflect back out of the panel. In addition, there are many appropriate materials from which these layers could be made, for example light-transmissive plastics or glass. As has been emphasised above, transmission in the infrared, visible, and/or ultraviolet parts of the electromagnetic spectrum is preferable, as these regions collectively account for the vast majority of incident solar radiation at the earth's surface.

While the panels may be made in any shape, a particularly advantageous shape for the panels is based on triangular shapes. For example, FIG. 3 shows a solar panel 302 having a substantially triangular shape. In fact, the shape is that of an irregular hexagon, or a truncated triangle, that is a triangle with the corners removed. The shape of the panel is such that it has three major edges 306, and three minor edges 308. The major edges 306 are arranged so that they lie along (that is, they are aligned with) the sides of a triangle 304, shown schematically by dashed lines in this figure. It is important to note that the triangle 304 is not part of the solar panel, but is shown solely for illustrative purposes, to highlight the triangular basis for the shape of the solar panel. Of course, it is possible that the major edges 306 of the solar panel extend all the way to the corners of the triangle 304, so that the panel 302 is itself triangular.

The panel shown in FIG. 3 is based on an equilateral triangle, but may be based instead on other triangles, depending on the desired application.

Turning now to FIGS. 4A and 4B, a plurality of solar panels 402, 403 are shown in a network 400. In FIG. 4A, a central panel 402 is surrounded by adjacent panels. Here, the panels are triangular in shape. In this figure, the panels 402, 403 can have inlets and outlets for exchanging target fluid with adjacent panels which are situated in the corners of the triangles. This means that there are regions 407, where many of the panels may couple to one another to exchange fluid. In this example, each region 407 has 6 panels linking to it. This means that the central panel 402 is able to link to 12 neighbours in total to exchange target fluid. This high degree of connectivity means that the resulting network is very flexible and can conform to convex, concave or circular shapes.

In FIG. 4B, the panels 402 each have the truncated triangle (or irregular hexagonal) shape. In addition, the network 400 is an irregular shape. It will be apparent that the overall shape of the network can be adapted to fit a wide range of shapes and sizes, by simply adding more panels where needed. In addition, the panels can be connected to one another so that the distance and/or angle between the panels can be adjusted. This allows the network to conform to the underlying geometry, even when it is not flat. It will further be appreciated that not all of the panels may be interconnected along their edges so that a larger gap can be left between some adjacent panels if this is necessary to conform to the underlying geometry.

At the locations where 6 panels 402 meet, there is a gap, due to the truncation of the triangular shape. This allows more space for a fluid interchange hub 407 that was possible using regular triangular shaped panels. In this example, the minor edges 408 include inlets and outlets for the panels, so that the panels can each exchange target fluid with adjacent panels, in any flow direction.

The flow of the target fluid around the network 400 can be controlled for a variety of reasons. Most importantly, there may be situations when a particular panel is significantly cooler than the others, perhaps because the sun has moved in the sky and that panel is now in shade. If the target fluid flows to that panel, then the overall heating power of the network will be reduced, and the fluid output at the end will be at a lower temperature. Therefore, it can be advantageous to divert the flow of the target fluid around the network by selectively closing inlet valves to particular panels so that cooler panels are bypassed.

Turning now to FIGS. 5A and 5B, some internal structure of the solar panels 502 is shown. In particular, FIG. 5A shows solar panel 502 with three internal walls 510, shaped to direct the flow of target fluid towards the centre of the panel 502. Once again, the inlets and outlets for this panel 502 are located in the minor edges 508 of the panel. A flow path 512 shows how fluid entering at the top left corner progresses through the panel. Instead of being able to travel along one major edge of the panel, and exit as soon as it reaches another minor edge, the fluid must flow almost the entire length of a major edge before making it to the centre of the panel. In order to exit the panel, the fluid must travel almost two further major edge's distance.

Considering now FIG. 5B, in which a similar internal structure is shown. However, in this case, there are six internal walls, 510a and 510b. In effect, this is the same design as that shown in FIG. 5A, but with a smaller version of the same design nested within the original one. It is clear that the path length 512 for the fluid to arrive at the centre of the panel in this figure is even longer than the one in FIG. 5A. Once at the centre, the fluid must traverse the same lengthy path in reverse, in order to exit the panel. It will be apparent to the skilled person that this process of nesting similar, but smaller versions of the internal structure of FIG. 5A can be repeated as often as desired, for example, forming a spiral structure.

It will be apparent to the skilled person that there are many different designs which could be used to increase the path length of the fluid as it travels through a panel. For example, while the examples in FIGS. 5A and 5B each use straight walls, curved walls could be used as well or instead.

As the incident solar radiation transitions from air into each of the layers of the solar panel system described herein, around 20% of the energy is lost through reflection. In order to reduce the loss of energy at each air/solid interface, a matching layer can be provided. The matching layer has a profile such that the impedance of the matching layer to electromagnetic radiation varies through the layer from a value close to the impedance of air to close to the impedance of the solid into which the radiation is passing. The matching layer can be attached to or formed on the surface of each solid layer, where the solid layer interfaces with air such that the matching layer enables the electromagnetic radiation to transition into and out of each layer while minimizing the loss of energy due to reflection and sudden changes in refractive index.

As a specific example, the outer or upper surface of the top glass layer of the solar panel is preferably coated with a matching layer to smooth the transition of electromagnetic radiation from the air into the glass layer. A further matching layer may be formed on the lower “exit” side of the glass layer to smooth the transition of the electromagnetic radiation back into the first insulating air gap.

The matching layer comprises a plurality of composites, strata or sub-layers, each of which has a gradually increasing impedance to the passage of electromagnetic radiation. A matching layer according to embodiments described herein is illustrated schematically in FIG. 9. The first composite 900 encountered by the incident radiation 906 has an impedance close to that of air. The final composite 904 prior to the incident radiation reaching the glass layer 908, has an impedance similar to that of glass. Intervening composites, and in the embodiment illustrated in FIG. 9 this is illustrated as a single intervening layer 902, have an impedance between that of air and glass.

Preferred embodiments for use with the solar panel system described herein include at least 2, preferably at least 3 composites or sub-layers. However, for other embodiments in which the transmission of a very high proportion of incident energy is important, a larger number of layers may be used. An impedance matching layer comprising 10, 20, 50 layers or more may be manufactured in accordance with the methods described herein. The difference in impedance between each layer in such an embodiment is very small such that the incident radiation would not perceive boundaries for reflection or refraction as it passed through each composite of the matching layer.

The composition of each of the composite layers is illustrated schematically in FIG. 8. In general, each composite is formed of a base carrier material 800 with an impedance similar to that of the material into which the electromagnetic energy is passing. In the solar panel embodiment, a suitable base carrier material is liquid silicone, which is transparent, inexpensive and easy to work with.

The base carrier material is divided into portions and each portion of the base carrier material is doped or mixed with different proportions of a dopant material 802 that has an impedance significantly lower than that of the carrier material. For the solar panel embodiment described herein, an aerogel based on carbon or silica would be a suitable dopant material. Use of an aerogel provides the added advantages that these materials are highly thermally insulating and the hydrophobic properties of aerogel also impart self-cleaning properties to the layer.

The aerogel is provided, or manufactured, in powdered form, which can be mixed directly into the carrier material, for example in a high shear mixing system such as that described herein.

The addition of aerogel to the liquid silicone reduces the impedance of the carrier material portions or composites. Each composite within the matching layer is doped in varying and increasing proportions with the aerogel to decrease the impedance of the carrier material until the impedance of the final composite is close to that of the air from which the radiation is received. In contrast, the impedance of the composite close to the solid, such as glass, into which the electromagnetic radiation is passing, is close to that of the solid layer.

The impedance of the composite positioned next to the solid surface (for example the glass layer) is within 30%, preferably within 20%, of the value of the impedance of the solid surface itself. The impedance of the composite positioned next to the air is within 30%, preferably within 20%, of the value of the impedance of the air.

In a particular embodiment, a silicone rubber is mixed with a silica-based aerogel in gradually increasing quantities to form composites for the matching layer. This results in an optically clear material with a hydrophobic surface and with a refractive index close to 1.

In addition, the silicone rubber and the silica aerogel are a particularly suitable combination, as the silicone rubber “optically grabs” the silica aerogel. That is, the boundary between these materials is not sharp, but behaves as if it were a more gradual boundary. This causes the silica aerogel to act more like a dopant, and less like a region of impurity which has a different impedance.

Once composites with different impedance values have each been mixed, each layer is rolled, or calendered into sheets or strips. The layers of varying impedance are then stacked on top of each other in decreasing order of impedance. A further calendering process is then used to compress the layers together to form the complete matching layer.

Apparatus for calendering is illustrated schematically in FIG. 10.The composite 1000 is fed into the calendering apparatus, which comprises two pairs of opposing rollers 1002a, 1002b, each roller in the pair rotating in opposite directions to cause the composite 1000 to pass between the rollers and to be extruded or rolled out into a flat layer or stratum. As will be appreciated by the skilled person, FIG. 10 is a schematic diagram of one embodiment of the calendering apparatus and many different types of calendering apparatus would be suitable for converting the composites into layers. In particular, 3 or more sets of rollers may be provided, each set of rollers having a smaller inter-roller spacing than the preceding set to calender the composites into thinner layers.

It will be appreciated that other types of calendering or extrusion equipment may also be used to form layers from the doped composites.

While two composites of different impedances may be sufficient in the matching layer to increase significantly the proportion of electromagnetic energy passing into the solar panel system, the matching layer preferably comprises at least 3 composites. In an exemplary embodiment, the impedance of the first composite in the matching layer is around 120% of the impedance of air, the impedance of the third layer is around 80% of that of the glass layer into which the radiation is passing, and the impedance of the second, middle layer lies roughly mid-way between the impedance of the first and third layers.

Once multiple composites with different doping levels have been formed and passed through a first calendering process, the impedance matching layer itself is formed by stacking the calendered composites in decreasing order of impedance and passing the stacked layers through another calendering apparatus.

Each composite may be formed to have a thickness which is equal to an odd multiple of a quarter of the wavelength of light in a part of the electromagnetic spectrum in which the solar energy received at the earth's surface is a maximum. This can help to transmit more of the energy at that wavelength through the layer. In practice, forming a layer to exactly this dimension is difficult, and more commonly a range of desired wavelengths is chosen, so that when the layer is produced it will have a thickness which is optimal for transmission of a wavelength within that range, even though a specific wavelength in that range would be hard to select.

Once formed, the impedance matching layer comprises a thin, substantially transparent film which can be covered in a pressure-sensitive adhesive for attaching to the surfaces of the solar panel layers where there is an interface from solid into fluid, including the interfaces between the glass/plastic and air layers and the interfaces between the glass/plastic and target/working fluid layers. Suitable adhesives include thin layers of acrylic or silicone adhesives.

In an alternative embodiment, however, the matching layer can be formed integrally with the solid layer when the solid layer is manufactured. This enables the matching layer to be formed and secured to the solid layer without the need for an intervening adhesive layer, which can introduce discontinuities in the impedance encountered by the incident radiation. Such integrally-formed embodiments may be particularly useful where the materials need to be optically-clear, such as those described in more detail below.

It will be appreciated by the skilled person that the matching layer described above has many applications beyond forming a matching layer for the transition of electromagnetic energy into and out of the layers of a solar panel. In particular, an optical impedance matching layer can be used to increase the transmissivity of any material designed to enable the transmission of electromagnetic radiation. In particular, the addition of an impedance matching layer to the inbound, and preferably outbound, surfaces of glass that forms a window or windscreen can increase the transmission of energy through the glass, which reduces reflections from the glass, hence increasing visibility through the glass itself. In particular embodiments, matching layers such as those described herein may be attached to windscreens of cars or aeroplanes. Similar matching layers may be applied as coatings for spectacles, sunglasses, visors or goggles. Matching layers such as those described herein can also be used to reduce reflections from glass surfaces, such as screens of electronic or computer equipment.

Another application of the impedance matching layer is in optical, astronomical, medical imaging and photographic equipment, where it may be applied to imaging equipment such as lenses, microscopes, telescopes, mirrors and light sources such as lasers.

In a further embodiment, a matching layer such as that described above can be used to create one way glass, which has a high transmissivity in one direction, but which presents a significant difference in optical impedance to light incident from the other direction, significantly reducing the transmissivity of light in that direction.

While the solar thermal system described above may be implemented with a number of different types of working fluids and target fluids, in a particular embodiment the working fluid advantageously comprises a nanofluid, that is a fluid in which are suspended nanoparticles. This embodiment will be described in more detail below.

The nanoparticles used in the present embodiment comprise carbon nanoparticles. These can be manufactured relatively inexpensively and possess useful properties with regard to absorption of light at visible wavelengths. In particular, an unmodified and unfiltered sample of carbon nanoparticles appears black as it contains a wide range of sizes of carbon nanoparticles, and in particular different diameters of carbon nanotubes, which each preferentially absorb different wavelengths of light across the visible spectrum.

Nanoparticle of Nickel Chromium Oxide, Nickel Oxide or Nickel Chromium can also be used in embodiments of the present system, either in place of the carbon nanoparticles or preferably in a mixture together with a larger proportion of the carbon nanoparticles. Alloys of nickel such as those listed are particularly useful in the working fluid of the present system since they have a low emissivity and readily absorb the incident radiation.

Use of nanoparticles within a fluid significantly increases the surface area within the fluid that is available to absorb the sun's energy. Increasing or maximising the absorbent surface area increases the capacity of the fluid to absorb the sun's energy. 1 m² of black plastic, which is traditionally used for absorbing the sun's energy in a thermal solar panel, has an absorbent surface area of 1 m². In contrast, 1 cm³ of nanofluid has a surface area of 1300 m³.

Hence, the nanoparticles within the fluid create a lot of surface area over which the sun's energy can be absorbed. In fact, each nanoparticle has the capacity to absorb so much energy that the absorbent capacity of a thin layer of the nanofluid is greater than the amount of radiation that is typically incident from the sun in a flat panel solar thermal system and the proportion of incident radiation absorbed is high. It will therefore be appreciated by the skilled person that the nanofluid described herein may also advantageously be used in a concentrated solar thermal system.

The nanofluid comprises a plurality of nanoparticles formed from carbon. It has been found that, in order to operate as an effective nanofluid in embodiments described herein, it is not necessary to use nanoparticles that are particularly uniform in shape or size. However, certain types of nanoparticles have been found to be effective for the systems described herein and these are highlighted and discussed in more detail below. Typically, however, a mixture of carbon particles of dimensions around 30-300 nm formed as tubes, spheres, fullerenes, plates or as irregular shapes can be used in the production of the working fluid described herein.

Such carbon nanoparticles can be purchased from a commercial source or can be formed using processes such as chemical vapour deposition of acetylene to form graphene, from which the carbon nanoparticles can be formed. In a particular process, a surfactant is mixed with the graphene using a mechanical mixing process, such as a pestle and mortar. As the surfactant coats the graphene, it functionalises the graphene by causing the graphene sheets to break into layers and to wrap into carbon nanotubes and nanoparticles, such as fullerene particles. The carbon nanotubes can either be closed tube structures, or may simply comprise a graphene layer rolled into a tube shape. The precise shapes, dimensions and degree of uniformity of the nanoparticles is not considered to be important in embodiments of the present system. In fact, providing a variety of shapes and dimensions of nanoparticles can assist in the absorption of electromagnetic energy across a broad spectrum. Further details of the surfactant are set out below.

To form the nanofluid to use as the working fluid within the solar thermal application described above, the carbon nanoparticles are mixed with a fluid. The nanoparticles should be mixed evenly throughout the fluid and dispersed within the fluid to maximise the surface area of the particles available for absorption of radiation.

As described in more detail below, the nanoparticles are mixed to form a colloid of nanoparticles, forming the dispersion phase, suspended in a fluid dispersion medium.

The nanoparticles can be mixed within the fluid using chemical additives to reduce their surface tension and surface energy and to overcome Van der Waals forces and intermolecular forces from hydrogen bonds sufficiently to enable dispersion within the fluid.

In particular, a surfactant has been found to be helpful to neutralise the hydrophobic properties of the nanoparticles and enable the particles to be dispersed more evenly throughout the fluid. Rather than adding additional surfactants at this processing stage, it has been found that the surfactant already present with the nanoparticles that remains from the functionalisation of the particles is sufficient to assist in the dispersion of the nanoparticles throughout the fluid when the particles are dispersed using the methods described below.

Suitable surfactants for use in functionalising and dispersing the nanoparticles within the fluid include simple soaps, particularly for use in water-based fluids, or lecithin, particularly with oil-based fluids.

It is also noted that, advantageously, benzene rings often remain attached to the carbon nanoparticles in the carbon residue, which increase the solubility of the carbon nanoparticles in oil-based dispersion fluids. The existence of such benzene rings reduces the need to add other agents to increase the solubility of the nanoparticles.

Therefore, while further chemicals could be added to actively promote dispersion within the fluid, surprisingly, it has been found that good dispersion of the nanoparticles within the fluid can be achieved using mechanical dispersion methods without the need for further chemical additives. An approach to this problem in which the number of chemicals used is minimised can improve the environmental impact of the nanofluid and can simplify and reduce costs in manufacturing.

Mechanical dispersion of the nanoparticles within the fluid can be achieved in particular using a very high shear mixing system or high shear homogeniser. There are many embodiments of such systems, but they typically include at least one rotating blade and at least one fixed stator for generating high shear forces within the fluid by causing adjacent portions of the fluid to move at different rates relative to each other. A simplified diagram of a basic high shear mixer is illustrated schematically in FIG. 6 to illustrate the principles of such a mixing method. In such a mixer, a shaped rotating blade or rotator 610 draws fluid upwards towards it and causes high rotational motion of the fluid that is nearest to it, relative to the body of the fluid as a whole. The fluid is then propelled outwards from the rotator through a static element, called a stator 612, which comprises a number of orifices 614. As the fluid passes through the orifices 614, elements within the fluid, in this case groups of nanoparticles, are broken up into smaller aggregations, or individual elements, hence increasing the dispersion of the particles through the fluid.

A more effective high shear mixer can be implemented using two sets of intermeshed concentric blades. Each blade is circular and comprises a number of teeth. One of the sets of blades is caused to rotate at high speed within the other set such that a rotating blade (rotator) is next to a static blade (stator), followed by further pairs of rotating and static blades to the edge of the mixer. Fluid is input to the centre of the rotating blades and drawn outwards through the rotating and static blades. As it passes through the mixer, particles within the fluid are disaggregated and dispersed.

The skilled person will appreciate that, while elements of a high shear mixing system have been described above, a number of different embodiments of such systems may be implemented to adequately disperse the particles within the fluid.

Very high shear mixing systems can provide an even dispersion of nanoparticles within the fluid and the particles are so dispersed and disaggregated that fluids mixed in this way have settlement times of many thousands, or even millions, of years.

Another high shear mixing system is shown in FIGS. 7A and 7B. Starting with FIG. 7A, a plan view of the mixing system 700 is shown. This comprises a central axis 706 to which means 704 for mounting a blade is rotatably mounted. Beneath the means 704 for mounting a blade is a surface 702. The surface is surrounded by a wall 710. In operation, fluid to be mixed is placed on the surface 702. The fluid is prevented from leaving the surface by the wall 710. The means for mounting a blade is then rotated around the central axis 706, as shown by the arrow 708.

In order to better show the effect of the movement of the means for mounting a blade while the fluid is on the surface 702, the arrangement 700 is shown from the side in FIG. 7B. Here a blade 705 is shown mounted on the means 704 for mounting a blade. The means 704 for mounting a blade is shown held a predetermined distance from the surface 702. The blade 705 contacts the surface, and bends, exerting a force on the surface 702. When the blade moves in the direction indicated by the arrow 708, it compresses the fluid 712a. Most of fluid 712a is pushed ahead of the blade, but a small proportion of the fluid 712a is squeezed under the blade 705, and forms a thin layer 712b behind the blade. As the fluid is squeezed under the blade, it is mixed in a high shear manner.

The smaller the distance between the means 704 for mounting the blade and the surface 702, the greater the force exerted by the blade (as it bends more), which causes higher shear mixing, while making the layer 712b behind the blade thinner. In an alternative arrangement, the blade does not contact the surface, and is instead held a short distance from the surface. The fluid is then mixed as it passes through the small gap.

Since the blade is rotatably mounted on the central axis, multiple rotations cause the fluid to be repeatedly mixed in this way. Alternatively, the system could comprise a linear movement of the blade relative to the surface, but it is preferable to have a rotational motion, since this allows repeated mixing in a simple manner.

The blade can be made of any material, depending on the elasticity requirements, and the shear force required. Similarly, the surface can be made of any material so long as it is hard and relatively smooth. There is no need for the surface to be flat or planar, so long as the blade conforms to the profile of the surface as it moves across it. In the specific application of making a working fluid for the solar panels described herein, it has been found that small metal particles bind to the carbon nanoparticles, reducing their ability to absorb radiation. Therefore for this use, non-metal blades and surfaces are recommended in such an embodiment. For example plastic or rubber blades and glass surfaces are suitable for this use.

Once the nanoparticles have been dispersed within the fluid dispersion medium, it is important that they are retained in suspension within the fluid and resist sedimentation and aggregation or flocculation. Viscous properties of the fluid within which the particles are dispersed can be used to slow these processes and maintain the particles in solution.

Fluids having a viscosity of greater than 500 cP (where 1 centipoise, 1 cP=1 mPa·s), preferably greater than 800 cP, are advantageous.

However, it is also beneficial if the nanoparticles are able to flow within the fluid dispersion medium to some extent, since this flow or mixing of nanoparticles can help in enabling the particles to remain suspended in the fluid. Therefore, the fluid should have a viscosity of less than 2500 cP, preferably less than 2000 cP, further preferably less than 1200 cP.

The viscosities set out above relate to the viscosities of the dispersion medium when the working fluid is cool, at around 20° C. The viscosity of an oil-based working fluid will decrease as its temperature rises. However, it is beneficial if the viscosity of the fluid at higher temperatures, when the fluid is exposed to incoming radiation, is lower than the viscosity at cool temperatures. Having a lower viscosity at the higher operating temperatures can enable the nanoparticles to move more freely as they absorb incident photons. This movement of the nanoparticles can help to distribute the heat energy more evenly throughout the fluid and can also help to stir the nanoparticles within the fluid, reducing sedimentation and keeping the particles distributed throughout the fluid. For this reason, the viscosity of the working fluid may fall to 500 cP or lower when the working fluid is absorbing incident radiation and is at its operating temperature.

Maintaining a relatively high fluid viscosity is more important, however, at times when there is no incident radiation to “stir” the nanoparticles within the fluid and sedimentation of the particles is more likely to occur. Therefore, discussion in the present application focusses on the viscosity of the fluid at cool temperatures. As discussed in more detail below, the addition of a wax to the dispersion medium may assist in both raising the viscosity of the dispersion medium and increasing the variation in viscosity between the cool fluid and the working fluid in operation.

Suitable fluids within which the nanoparticles are suspended can be water-based or oil-based. The lower specific heat capacity of oil compared to that of water means that the increase in temperature for an oil-based fluid will be greater than that for a water-based fluid for the same incident radiation. This enables the working fluid to heat up and cool down more quickly, reducing the amount of heat stored in the working fluid and increasing the speed with which the target fluid can start to be heated once the panel is exposed to incident radiation. Oils also tend to have a lower freezing point and a higher boiling point than water and many are outside the temperature ranges that a solar thermal panel would expect to encounter under normal environmental conditions. Oils also tend to have higher viscosity than water, which is helpful in retaining the nanoparticles in suspension. There are therefore a number of advantages to using an oil-based fluid. However, water is readily available, non-polluting and can be adapted as described herein to carry the nanoparticles in the working fluid as described herein.

Suitable oils may include hydrocarbon oils, but natural or organic oils are preferred including castor oil, soybean oil, coconut oil or palm oil. In particular, castor bean oil, or castor oil, has a viscosity of around 1000 cP and would be a suitable dispersion medium to use even without the addition of additives.

Whether the working fluid is oil or water based, it may be necessary to increase its viscosity to bring it within the range described above. A number of additives can be mixed with the base fluid in order to increase its viscosity to above 500 cP, preferably to around 1000 cP. High viscosity fluids that may be used include silicones or heavier oils; however, such materials are less environmentally desirable and may increase problems for the end of life disposal of the solar panels. Therefore, an organic material is preferred and suitable materials include agar, gum aribica, extracted natural products such as barnacle extract. Another material that may be used to increase the viscosity of the carrier fluid is lecithin, in particular soy lecithin or a synthetic version.

In a particular embodiment, a wax is mixed with the dispersion medium of the working fluid. The wax can be used to increase the viscosity of the dispersion medium, where this is necessary. However, use of a wax within the dispersion medium is also helpful to increase the viscosity differential of the fluid between a cool non-operating temperature and a hot operating temperature. That is, the wax can be used to increase the viscosity of the fluid at cool temperatures and hence hold the nanoparticles more firmly in suspension when the solar panel is not receiving incoming radiation, for example at night. In preferred embodiments, the viscosity of the wax may increase to around 2000-2500 cP when the system is cool, at around 20° C.

Suitable waxes include naturally-occurring waxes such as beeswax and carnauba wax or a hydrocarbon wax such as paraffin wax. Such waxes mix well with the oil-based dispersion media described above and operate to change their viscosity in an even and predictable way. Carnauba wax is particularly suitable for use in systems described herein since it is a high temperature wax with a melting point of around 90° C. Therefore, the viscosity of the dispersion medium as a whole decreases only at a higher temperature and the nanoparticles are held more securely in suspension until higher energy levels are reached within the dispersion medium.

The addition of waxes as described above also enables the manufacturer of the working fluid to fine-tune the viscosity of the working fluid for a particular temperature-range that a particular solar panel is expected to encounter. For example, a solar panel for deployment at higher latitudes or altitudes is likely to have a cooler resting temperature than a solar panel deployed at lower latitudes. Therefore, the amount of wax in the dispersion medium can be reduced for lower temperature panels.

While a high viscosity is desirable to reduce sedimentation of the nanoparticles, the viscosity should not be so high as to preclude all convective flow within the working fluid. As noted above, convective flow is helpful in mixing the nanoparticles through the fluid in use and in maintaining an even heat distribution within the working fluid.

A further property of a suitable fluid for carrying the nanoparticles is that it should have high optical coupling with the nanoparticles themselves. That is, the incident electromagnetic energy should be able to pass from the fluid into the nanoparticles without encountering a significant interface between the two media. Matching of the optical impedance of the two materials, preferably to within 20% of the impedance value, is one factor that increases the optical coupling between the two elements of the nanofluid. A high optical coupling can enable the incident light, or photons, to be reflected around within the carrier fluid until they are absorbed by a nanoparticle, such that absorption by nanoparticles is enabled over the 360° surrounding the nanoparticle.

It has been found that it is advantageous to use nanoparticles within the nanofluid that contain a high proportion of nanotubes, for example more than 50% nanotubes. It has been found by the present inventor that the shape of the nanotubes and the way that the electrons are able to move within the nanotubes increases the ability of this particular shape of nanoparticle to absorb electromagnetic radiation. In particular, the nanotubes can act as antennae tuned to, and resonating with, the incident electromagnetic radiation. These resonant properties of the nanotubes increase the likelihood of a photon interacting with and being absorbed by a nanotube as it passes through the working fluid.

Further additives to the working fluid can also increase its capability for the absorption of incident energy. In particular, the addition of small quantities of a high transmissivity material has been found to significantly increase the ability of the nanofluid to absorb incident radiation.

The addition of a high transmissivity material “tunes” the circuit formed by the nanoparticles such that the resonant frequency of the circuit matches the resonant frequency of the incoming electromagnetic signal. The addition of particular additives in particular proportions can tune the nanoparticles to absorb incoming radiation more strongly at particular frequencies, for example at visible and ultraviolet frequencies. It can be helpful to tune the nanoparticles to absorb at these frequencies since the working fluid (water) is more highly absorbent in other bands of the spectrum, for example around the infrared frequencies.

High transmissivity materials encompass any material with a transmissivity greater than at least about 70% and suitable materials include Calcium Fluoride, CaF₂ (also known as fluorspar), Silicon Dioxide in a crystalline form, SiO₂ (also known as silica), Indium Tin Oxide, ITO, Aluminium-doped Tin Oxide, AZO, and Indium-doped Cadmium Oxide.

Crystalline forms of SiO₂ that are particularly useful as an additive in the present system are those with higher densities, which have corresponding high refractive indices. In particular, crystalline forms with densities of 2.5-3 g/cm³ or greater have been found to be most effective. These forms have a refractive index of around 1.5 to 1.55.

Particularly suitable materials, including CaF₂ and SiO₂, have both high transmissivity and high refractive indices.

The additive is required only in small quantities, in particular less than 0.1%, preferably around 0.01% of the amount of nanoparticles present in the fluid, and should be substantially homogeneously dispersed throughout the carrier fluid.

The additive alters the optical properties of the nanofluid, in particular due to the different mass of its particles and alters the optical connection between the carrier fluid and the particles, increasing the ability of the nanoparticles to absorb the incident radiation. In particular, materials with high transmissivity and high refractive index may help to increase the effective path length of the light through the nanofluid working fluid layer, hence increasing the likelihood of a particular photon of light being absorbed by the carbon nanoparticles.

Incident solar radiation is absorbed into the target fluid, either directly or via absorption and retransmission by the working fluid, as described above. In view of the increased absorption capacity of the carbon-nanoparticle-carrying working fluid, the fluid heats up quickly, and a significant difference in temperature between the working fluid and the target fluid is beneficial in facilitating heat transfer into the target fluid. However, the system should not be designed simply to maximise the temperature difference between the fluids. In fact, it is advantageous to transfer heat from the working fluid into the target fluid as quickly as possible as any increase in temperature of the working fluid will decrease its ability to absorb further solar radiation (since the difference in temperature between the sun and the working fluid will decrease). The working fluid reaches temperatures of greater than 100° C., typically around 160-190° C. Such temperatures allow heating of the target fluid to above 150° C., preferably to around 160° C.

As will be appreciated by the skilled person, heat loss from the panel can become significant at these temperatures, since the insulating properties of the panel are necessarily limited. Further, degradation of components of the panel will also start to occur particularly if elements of the panel are held at very high temperatures for an extended period. Therefore, it is important to enable efficient transfer of the heat energy to be transferred into the target fluid.

As described above, the working fluid absorbs visible and infrared energy and converts both into infrared energy (converting the wavelength from 300-1000 nm to 5000 nm-10,000 nm). Since water is opaque to infrared energy, the target fluid comprising water readily absorbs the infrared energy emitted by the working fluid. Hence absorption of the energy by the nanoparticles in the working fluid and retransmission of this energy as radiant infrared energy enables efficient collection of the energy in the target fluid.

It is noted that the energy is largely transferred into the target fluid using radiant transfer from the surface of one fluid to the other, rather than by thermal conductivity (although a small amount of conductive transfer of the energy would be expected). Placing an extended surface of the working fluid close to that of the target fluid, as described in the solar panels illustrated in FIGS. 1 and 2 enables efficient radiant transfer of the infrared energy from one fluid to the other.

FIGS. 11A to 11C show a diaphragm 1100. In particular, FIG. 11A shows a diaphragm in two states, a normal state 1100 and an inverted state 1101. In the normal state, the diaphragm is below a particular temperature, called the inversion temperature. Once the diaphragm has been heated to the inversion temperature, thermal expansion stresses build up and cause the diaphragm to invert, resulting in the inverted state 1101. This process is entirely reversible; when the temperature drops below the inversion temperature again, the diaphragm returns to the normal state.

This may find use in valves to control flow into certain panels in a network. For example, in the description of FIGS. 4A and 4B, the flow path may be selected to bypass cooler panels. Therefore, by placing a temperature sensitive valve at the inlet to such panels, the network can have an inherent bypassing functionality built into it.

This is demonstrated schematically in FIGS. 11B and 11C. It will be appreciated that the size of the pipe and the curvature of the diaphragm have been exaggerated in FIGS. 11B and 11C to enable the principles of operation to be more easily demonstrated. In FIG. 11B, a pipe 1102 is shown in which a diaphragm is mounted. In this example, the temperature is higher than the inversion temperature, and the diaphragm is in the inverted state 1101, which leaves the pipe 1102 is clear, and fluid is able to flow. In this case, the flow path which is open is an inlet to a solar panel. The diaphragm is mounted in the pipe 1102 by mounting means 1104 which do not affect the diaphragm's ability to invert.

In FIG. 11C, the temperature has dropped below the inversion temperature, and the diaphragm has returned to the normal state 1100. In this example, this means that it extends into the pipe 1102 and blocks it, thereby preventing fluid flow into the solar panel. When the solar panel heats up again, the hot target fluid will cause the diaphragm to heat up, and eventually invert and open the pipe to enable fluid to flow. As long as the target fluid flowing through the pipe stays hotter than the inversion temperature, the diaphragm remains in the inverted state, and fluid can flow.

As the skilled person will appreciate, other designs of thermal valve are possible. For example, a valve could be constructed which uses thermal expansion to exert a linear motion to press a pipe closed. While the diaphragms in FIGS. 11A to 11C are shown as having a constant thickness, the diaphragms may have a thickness which varies. Changing the geometry of the diaphragm is one way of changing the temperature at which the diaphragm inverts. Suitable materials for making the diaphragm from are plastics materials, for example polyvinylidene fluoride (PVDF) or polypropylene. Diaphragms can even be constructed from two or more different materials, and the differing thermal responses of the two materials can be used to tailor the inversion temperature. Plastics are suitable materials as they have good resistance to fatigue.

The inversion temperature is a parameter of the network that can be selected, depending on the intended use. For example, 40° C. is a comfortable temperature for washing, 60° C. is a temperature at which water-borne pathogens start to die.

It is also possible to design diaphragms so that they have two inversion temperatures, an upper one and a lower one. This introduces a degree of hysteresis into the system, and helps prevent unstable oscillations of the diaphragm valves near to the inversion temperature. For example, the temperature at which the diaphragm changes from the normal to inverted state may be 10° C. higher than the temperature at which it changes from the inverted state to the normal state. In the 10° C. window between these two states, the diaphragm takes on the configuration it most recently had.

The panel and systems described herein may be used directly for drinking, cooking, heating or washing, or may be used for sterilising, pasteurising other fluids or items. For example, the system can be used as a domestic hot water heating system or a home heating or cooling system. Alternatively, one or more panels may be used in an industrial preheater for processes including distillation, desalination or drying of materials such as food crops.

In a particular embodiment, the system may have medical uses in the cleaning and sterilisation of surgical or medical equipment or in the preparation of medicines and vaccines.

The system may also be deployed for example in the pre-treatment of sewage or in the preheating of fluids for use in a power plant.

1-25. (canceled)

26. A solar energy system for heating a target fluid using incident solar radiation, the system comprising:
a protective upper layer;
a target fluid layer comprising the target fluid;
a light transmissive inter-fluidic dividing layer;
a working fluid layer comprising a working fluid; and
a lower retaining layer.

27. The system according to claim 26, wherein the inter-fluidic dividing layer is transparent.

28. The system according to claim 26, wherein the inter-fluidic dividing layer is translucent or transmits light in a diffusive manner.

29. The system according to claim 26, wherein the inter-fluidic dividing layer is transmissive to light in both the infrared and visible parts of the electromagnetic spectrum.

30. The system according to claim 26, wherein both the target fluid and the working fluid are liquid.

31. The system according to claim 26, further comprising at least one of a pump or a siphon for circulating the target fluid through the target fluid layer of the system.

32. The system according to claim 26, wherein the target fluid and the working fluid are arranged such that incoming solar radiation passes through the target fluid prior to passing into the working fluid.

33. The system according to claim 26, wherein the target fluid comprises at least one of oil or water.

34. (canceled)

35. The system according to claim 26, wherein the working fluid comprises a colloid comprising a dispersed phase of nanoparticles.

36. The system according to claim 35, where the nanoparticles comprise carbon nanoparticles.

37. The system according to claim 35, wherein the colloid comprises a dispersion medium comprising at least one of water or oil.

38. (canceled)

39. The system according to claim 35, wherein the colloid comprises a dispersion medium and a high viscosity fluid for thickening the dispersion medium.

40. The system according to claim 26, wherein the absorbance of the incident radiation in the working fluid is greater than the absorbance of the incident radiation in the target fluid for at least a portion of the spectrum of the incident solar radiation.

41. The system according to claim 40, wherein the portion of the spectrum comprises visible wavelengths.

42. The system according to claim 26, wherein the working fluid emits absorbed radiation at infrared wavelengths.

43. The system according to claim 26, further comprising an upper insulating layer.

44. The system according to claim 26, wherein the lower retaining layer comprises a reflective layer for reflecting radiation back through the overlying layers.

45. The system according to claim 26, wherein the transfer of energy between the working fluid and the target fluid predominantly comprises radiant transfer.

46-80. (canceled)

81. The system according to claim 26, further comprising at least one solar panel for heating the target fluid using incident solar radiation, the solar panel comprising:
three major edges arranged so that the solar panel can be inscribed in a triangle with each major edge of the panel lying along at least a portion of a side of the triangle;
a cavity for retaining the target fluid; and
an inlet and an outlet for the target fluid, for exchanging the target fluid with adjacent solar panels.

82. The system according to claim 26, further comprising a network of solar panels for heating the target fluid using incident solar radiation, the network comprising:
a first solar panel; and
a second solar panel;
wherein the first and second solar panels each include a cavity for retaining the target fluid, and the first and second solar panels are coupled together to allow the target fluid to flow between them; and
further comprising one or more inlets, each respective inlet coupled with a corresponding one of the first and second solar panels, the one or more inlets configured for selectively enabling fluid flow into each panel.
